(19) United States
(12) Patent Application Publication
(10) Pub. No.: US 2026/0352309 A1
(43) Pub. Date: Nov. 5, 2026

(54) INFORMATION TRANSMISSION METHOD AND COMMUNICATION APPARATUS

(71) Applicant: SPREADTRUM COMMUNICATIONS (SHANGHAI) CO., LTD., Shanghai (CN)

(72) Inventor: Xu LIU, Shanghai (CN)

(21) Appl. No.: 19/484,801

(22) PCT Filed: May 14, 2024
(86) PCT No.: PCT/CN2024/093057

§ 371 Date: Nov. 14, 2025

(30) Foreign Application Priority Data
May 15, 2023 (CN) 202310547318.0

(51) Int. Cl. H04B 7/06; H04B 7/185

(52) U.S. Cl. CPC H04B 7/06952; H04B 7/18554

(57) ABSTRACT

The present application discloses an information transmission method and a communication apparatus. The method may comprise: determining beam illumination information corresponding to at least one piece of beam position information, sending said beam illumination information to a terminal device, and correspondingly, the terminal device receiving said beam illumination information from a network device. Said beam illumination information comprises an illuminated beam index and illuminated beam time information. By applying the embodiments of the present application, beam positions within the coverage of a satellite can be scanned according to a service volume, thereby facilitating improving the communication quality and the resource utilization.

The present application claims priority to CN Patent Application No. 202310547318.0, entitled “INFORMATION TRANSMISSION METHOD AND COMMUNCATION APPARATUS”, and filed with the China National Intellectual Property Administration on May 15, 2023, the entity of which is incorporated herein by reference.

### FIELD OF TECHNOLOGY

The present application relates to communication technology, and particularly to a method for information transmission and a communication apparatus.

### BACKGROUND

To achieve communication of terminal devices in areas with no basic network infrastructure (for example, infrastructure such as a base station), non-terrestrial network (NTN) communication has emerged. Non-terrestrial network communication may also be referred to simply as non-terrestrial communication.

Communication via satellite is a form of non-terrestrial communication, allowing any two terminal devices within the coverage area of the satellite to communicate, unaffected by geological disasters. The satellite may transmit at least one beam. The at least one beam continuously scans within the satellite's coverage area, thereby providing services to terminal devices within the coverage area. For a satellite, its coverage area may be divided into a plurality of beam positions, and each beam position is scanned by a beam in an equalized manner. That is, the dwell time for service of the beam at each beam position is the same or similar. However, the service load in the geographical area corresponding to each of the beam positions within the satellite's coverage area is typically uneven. If the beam keeps scanning each beam position in an equalized manner, communication quality and resource utilization would be affected to some extent.

### SUMMARY OF THE INVENTION

Embodiments of the present application provide a method for information transmission and a communication apparatus, which contribute to enhancing communication quality and resource utilization.

In a first aspect, embodiments of the present application provide a method for information transmission. The method may be performed by a network device, or by an apparatus configured for use with a network device, such as a processor, a chip, or a chip module and the like. The method may comprise: determining beam illumination information corresponding to at least one piece of beam position information; and transmitting the beam illumination information corresponding to the at least one piece of beam position information to a terminal device, where the beam illumination information corresponding to the at least one piece of beam position information includes an index of illuminating beam and time information of illuminating beam.

As can be seen, by determining and distributing the beam illumination information corresponding to the at least one piece of beam position information, each beam position within a satellite's coverage area is scanned based on for example service load rather than in an equalized manner, which contributes to enhancing communication quality and resource utilization. The beam illumination information corresponding to the at least one piece of beam position information includes an index of illuminating beam and time information of illuminating beam, so that the time information of illuminating beam corresponding to the index of illuminating beam is determined, allowing the terminal device to communicate within the time from the time information of illuminating beam corresponding to the index of illuminating beam, which contributes to enhancing communication quality and resource utilization.

Alternatively, determining the beam illumination information corresponding to the at least one piece of beam position information may include: determining the beam illumination information corresponding to the at least one piece of beam position information based on current service load of the beam position(s) corresponding to the at least one piece of beam position information and/or historical service load of the beam position(s) corresponding to the at least one piece of beam position information. As can be seen, the network device can determine the beam illumination information based on the current service load and/or historical service load of the beam position(s) corresponding to the beam position information, so that each beam position within the satellite's coverage area can be scanned based on service load, thereby contributing to the enhancement of communication quality and resource utilization.

In an implementation, the time information of illuminating beam includes a period of illumination and a duration of illumination within the period of illumination, or the time information of illuminating beam includes a start time of illumination and a duration of illumination. That is, the time information of illuminating beam may be used to describe the time information of periodic illumination of the illuminating beam or may be used to describe the time information of aperiodic illumination of the illuminating beam.

In an implementation, the method further comprises: transmitting the at least one piece of beam position information to the terminal device, where the at least one piece of beam position information includes geographical location information corresponding to each beam position of at least one beam position. That is, the beam position information may be used to describe the geographical location information corresponding to a beam position within the satellite's coverage area, where the geographical location information may be, for example, longitude and latitude information. Associating the beam position with the geographical location information through beam position information allows the terminal device to determine the beam illumination information corresponding to current geographical location information according to the current geographical location and the at least one piece of beam position information.

In an implementation, the method further comprises: transmitting at least one piece of time validity information to the terminal device, where a piece of time validity information is used to indicate information on valid time for the beam illumination information corresponding to that piece of time validity information. That is, a piece of beam illumination information has time validity information, which may indicate information on valid time for that piece of beam illumination information. For example, the time validity information may include one or more of the following information: a start time of validity, a duration of validity, an end time of validity, etc.

In an implementation, the beam illumination information corresponding to the at least one piece of beam position information is carried in first information, where the first information is broadcast information, downlink control information (DCI), radio resource control (RRC) signaling, or media access control-control element (MAC-CE) signaling. Distributing the beam illumination information corresponding to the at least one piece of beam position information via broadcast information allows a relatively large number of terminal devices to receive the beam illumination information corresponding to the at least one piece of beam position information. Distributing the beam illumination information corresponding to the at least one piece of beam position information via DCI, RRC signaling, or MAC-CE signaling may be understood as distributing the beam illumination information corresponding to the at least one piece of beam position information via dedicated signaling, thereby making the beam illumination information corresponding to the at least one piece of beam position information target-specific.

In an implementation, the method further comprises: receiving first beam position information from the terminal device, where the first beam position information is the beam position information corresponding to current geographical location information; and transmitting updated beam illumination information corresponding to the first beam position information to the terminal device. The terminal device reports the first beam position information corresponding to the current geographical location information to the network device. When the network device detects that the beam illumination information corresponding to the first beam position information can be updated, it returns the updated beam illumination information corresponding to the first beam position information to the terminal device. The terminal device acquires a piece of valid and updated beam illumination information to ensure data transmission, that is, the terminal device remains accessible during data transmission.

In an implementation, the updated beam illumination information corresponding to the first beam position information is carried in second information, and the second information is broadcast information, DCI, RRC signaling, or MAC-CE signaling.

In an implementation, the method further comprises: receiving a first request message from the terminal device, where the first request message includes the first beam position information, and the first request message is used to request the updated beam illumination information corresponding to the first beam position information, where the first beam position information is the beam position information corresponding to the current geographical location information; and transmitting a first response message to the terminal device, where the first response message includes the updated beam illumination information corresponding to the first beam position information. The terminal device requests the updated beam illumination information corresponding to the first beam position information from the network device, and the network device returns the updated beam illumination information corresponding to the first beam position information to the terminal device. The terminal device acquires a piece of valid and updated beam illumination information to ensure data transmission, that is, the terminal device remains accessible during data transmission.

In an implementation, the method further comprises at least one of the following:
receiving second beam position information from the terminal device;
receiving a second request message from the terminal device, where the second request message includes the second beam position information, and the second request message is used to request the beam illumination information corresponding to the second beam position information;
where, the second beam position information is the beam position information corresponding to the geographical location information of the terminal device after the movement of the terminal device.

As can be seen, in case where a change in the geographical location information of the terminal device leads to a change in the beam position information, the terminal device may request to acquire the beam illumination information corresponding to the changed beam position information, thereby ensuring data transmission.

In an implementation, the method further comprises: transmitting the beam illumination information corresponding to the second beam position information to the terminal device.

In a second aspect, embodiments of the present application provide a method for information transmission. The method may be performed by a terminal device, or by an apparatus configured for use with a terminal device, such as a processor, a chip, or a chip module and the like. The method may comprise: receiving beam illumination information corresponding to at least one piece of beam position information from a network device, where the beam illumination information corresponding to the at least one piece of beam position information includes an index of illuminating beam and time information of illuminating beam.

As can be seen, by receiving the beam illumination information corresponding to the at least one piece of beam position information, each beam position within a satellite's coverage area is scanned based on for example service load rather than in an equalized manner, which contributes to enhancing communication quality and resource utilization. The beam illumination information corresponding to the at least one piece of beam position information includes an index of illuminating beam and time information of illuminating beam, so that the time information of illuminating beam corresponding to the index of illuminating beam is determined, allowing the terminal device to communicate within the time from the time information of illuminating beam corresponding to the index of illuminating beam, which contributes to enhancing communication quality and resource utilization.

In an implementation, the time information of illuminating beam includes a period of illumination and a duration of illumination within the period of illumination, or the time information of illuminating beam includes a start time of illumination and a duration of illumination. That is, the time information of illuminating beam may be used to describe the time information of periodic illumincation of the illuminating beam or may be used to describe the time information of aperiodic illumination of the illuminable beam.

In an implementation, the method further comprises: receiving the at least one beam position information, where the at least one beam position information includes geographical location information corresponding to each beam position of at least one beam position. That is, beam position information may be used to describe the geographical location information corresponding to beam position(s) within the satellite's coverage area, where the geographical location information may be, for example, longitude and latitude information. Associating the beam position with the geographical location information through beam position information allows the terminal device to determine the beam illumination information corresponding to current geographical location information based on the current geographical location information and the at least one piece of beam position information.

In an implementation, the method further comprises: in response to first beam position information corresponding to the current geographical location information, determining first beam illumination information corresponding to the first beam position information from the beam illumination information corresponding to the at least one piece of beam position information, where the first beam position information is determined based on the geographical location information corresponding to each beam position and the current geographical location information. That is, the terminal device determines the first beam position information corresponding to the current geographical location information based on the geographical location information corresponding to each beam position, and further determines the first beam illumination information corresponding to the first beam position information.

In an implementation, the method further comprises: receiving at least one piece of time validity information from the network device, where a piece of time validity information is used to indicate information on valid time for the beam illumination information corresponding to that piece of time validity information. That is, a piece of beam illumination information has time validity information, which may indicate information on valid time for that beam illumination information. For example, the time validity information may include one or more of the following information: a start time of validity, a duration of validity, an end time of validity, etc.

In an implementation, the beam illumination information corresponding to the at least one piece of beam position information is carried in first information, where the first information is broadcast information, DCI, RRC signaling, or MAC-CE signaling. Distributing the beam illumination information corresponding to the at least one piece of beam position information via broadcast information allows a relatively large number of terminal devices to receive the beam illumination information corresponding to the at least one piece of beam position information. Distributing the beam illumination information corresponding to the at least one piece of beam position information via DCI, RRC signaling, or MAC-CE signaling may be understood as distributing the beam illumination information corresponding to the at least one piece of beam position information via dedicated signaling, thereby making the beam illumination information corresponding to the at least one piece of beam position information target-specific.

In an implementation, the method further comprises: transmitting first beam position information to the network device, where the first beam position information is the beam position information corresponding to current geographical location information; and receiving updated beam illumination information corresponding to the first beam position information from the network device. The terminal device reports the first beam position information corresponding to the current geographical location information to the network device. When the network device detects that the beam illumination information corresponding to the first beam position information can be updated, it returns the updated beam illumination information corresponding to the first beam position information to the terminal device. The terminal device acquires a piece of valid and updated beam illumination information to ensure data transmission, that is, the terminal device remains accessible during data transmission.

In an implementation, the updated beam illumination information corresponding to the first beam position information is carried in second information, and the second information is broadcast information, DCI, RRC signaling, or MAC-CE signaling.

In an implementation, the method further comprises: transmitting a first request message to the network device, where the first request message includes the first beam position information, and the first request message is used to request the updated beam illumination information corresponding to the first beam position information, where the first beam position information is the beam position information corresponding to the current geographical location information; and receiving a first response message from the network device, where the first response message includes the updated beam illumination information corresponding to the first beam position information. The terminal device requests the updated beam illumination information corresponding to the first beam position information from the network device, and the network device returns the updated beam illumination information corresponding to the first beam position information to the terminal device. The terminal device acquires a piece of valid and updated beam illumination information to ensure data transmission, that is, the terminal device remains accessible during data transmission.

In an implementation, the method further comprises at least one of the following:
transmitting second beam position information to the network device;
transmitting a second request message to the network device, where the second request message includes the second beam position information, and the second request message is used to request the beam illumination information corresponding to the second beam position information;
where, the second beam position information is the beam position information corresponding to the geographical location information of the terminal device after the movement of the terminal device.

As can be seen, in case where a change in the geographical location information of the terminal device leads to a change in the beam position information, the terminal device may request to acquire the beam illumination information corresponding to the changed beam position information, thereby ensuring data transmission.

In an implementation, the method further comprises: receiving the beam illumination information corresponding to the second beam position information from the network device.

In a third aspect, embodiments of the present application provide a communication apparatus. The communication apparatus comprises:
a processing unit configured to determine beam illumination information corresponding to at least one piece of beam position information;
a communication unit configured to transmit the beam illumination information corresponding to the at least one piece of beam position information to a terminal device;
where the beam illumination information corresponding to the at least one piece of beam position information includes an index of illuminating beam and time information of illuminating beam.

In a fourth aspect, embodiments of the present application provide a communication apparatus. The communication apparatus comprises:
a communication unit configured to receive beam illumination information corresponding to at least one piece of beam position information from a network device, where the beam illumination information corresponding to the at least one piece of beam position information includes an index of illuminating beam and time information of illuminating beam.

In a fifth aspect, embodiments of the present application provide a terminal device, comprising: a processor, a memory, and computer programs or instructions stored on the memory, wherein the processor executes the computer programs or instructions to implement the steps of method involved in the second aspect mentioned above.

In a sixth aspect, embodiments of the present application provide a network device, comprising: a processor, a memory, and computer programs or instructions stored on the memory, wherein the processor executes the computer programs or instructions to implement the steps of the method involved in the first aspect mentioned above.

In a seventh aspect, the embodiments of the present application provide a chip, including a processor, wherein the processor executes the steps of the method involved in the first aspect mentioned above, or executes the steps of the method involved in the second aspect mentioned above.

In an eighth aspect, the embodiments of the present application provide a chip module, comprising: a communication interface and a chip, the chip comprising a processor, wherein the processor executes the steps of the method involved in the first aspect mentioned above, or executes the steps of the method involved in the second aspect mentioned above.

In a ninth aspect, the embodiments of the present application provide a computer-readable storage medium having computer programs or instructions stored therein, the computer programs or instructions when being executed, implementing the steps of the method involved in the first aspect mentioned above or implementing the steps of the method involved in the second aspect mentioned above.

In a tenth aspect, the embodiments of the present application provide a computer program product, including computer programs or instructions, the computer programs or instructions when being executed, implementing the steps of the method involved in the first aspect mentioned above or implementing the steps of the method involved in the second aspect mentioned above.

### BRIEF DESCRIPTION OF THE DRAWINGS

FIG. 1 is a schematic diagram of a system architecture applied to an embodiment of the present application;

FIG. 2 is an exemplary diagram of beams and beam positions;

FIG. 3 is a schematic flowchart of a method for information transmission provided by an embodiment of the present application;

FIG. 3A is a schematic flowchart of another method for information transmission provided by an embodiment of the present application;

FIG. 3-1 is an examplary diagram of beams illuminating in a periodic manner provided by an embodiment of the present application;

FIG. 3-2 is an examplary diagram of beams illuminating in an aperiodic manner provided by an embodiment of the present application;

FIG. 4 is a schematic structural diagram of a communication apparatus provided by an embodiment of the present application;

FIG. 5 is a schematic structural diagram of another communication apparatus provided by an embodiment of the present application; and

FIG. 6 is a schematic structural diagram of a chip module provided by an embodiment of the present application.

### DETAILED DESCRIPTION OF EMBODIMENTS

In the present application, terms such as “first” and “second” are used to distinguish between identical items or similar items that have substantially the same functionality and effect. Those skilled in the art will understand that terms such as “first” and “second” do not pose limitation on the quantity and order of execution, and that the terms such as “first” and “second” also do not limit that they are different. The term “and/or” describes a relationship between related objects, indicating that three types of relationships may exist. For example, A and/or B may indicate: A alone, both A and B, or B alone. The character “/” generally indicates an “or” relation between the two objects before and after the character.

It should be understood that in the present application, “at least one” refers to one or more, and “a plurality of” refers to two or more. Furthermore, the term “equal to” in the present application may be used together with the terms “greater than” or “less than”. When “equal to” is used together with “greater than”, the technical solution of “greater than” is adopted; when “equal to” is used together with “less than”, the technical solution of “less than” is adopted.

Firstly, the system architecture related in the present application is illustrated.

The present application may be applied to fourth-generation (4G) systems; or may be applied to fifth-generation (5G) systems, also referred to as New Radio (NR) systems; or may be applied to sixth-generation (6G) systems, or seventh-generation (7G) systems, or other future communication systems. It may also be used in device-to-device (D2D) systems, machine-to-machine (M2M) systems, vehicle-to-everything (V2X) systems, etc.

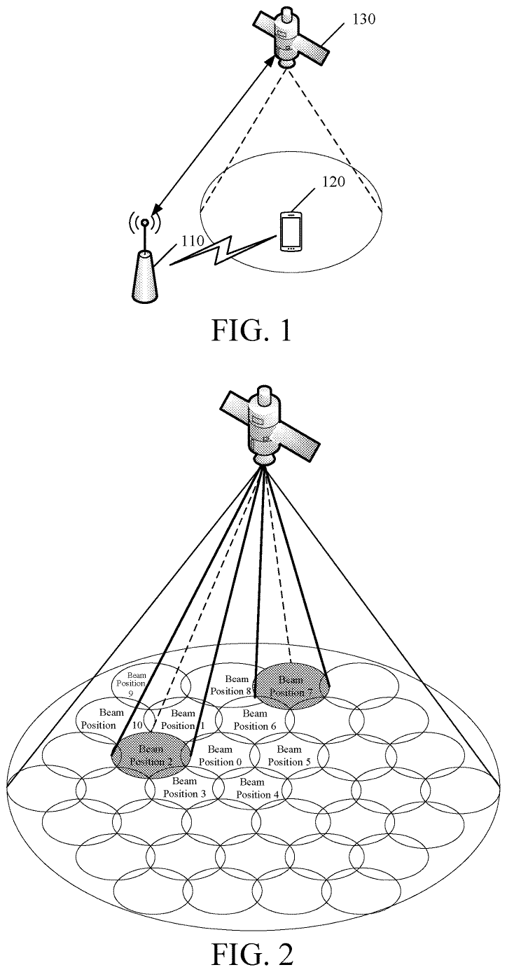

The present application may be applied to the system architecture shown in FIG. 1.The communication system 10 shown in FIG. 1 may include but is not limited to: a network device 110, a terminal device 120, and a satellite 130.The number and form of devices in FIG. 1 are for illustrative purposes only and shall not be construed as limiting the embodiments of the prensent application. An actual implementation may, for example, incorporate a plurality of terminal devices.

A terminal device, also known as a terminal, a user equipment (UE), a mobile station (MS), or a mobile terminal (MT), refers to a device that provides voice and/or data connectivity to a user. Examples may include handheld devices, vehicle-mounted devices, and the like. Currently, examples of some terminal devices include: mobile phones, tablets, laptops, palmtop computers, Mobile Internet Devices (MIDs), wearable devices, Virtual Reality (VR) devices, Augmented Reality (AR) devices, Mixed Reality (MR) devices, Extended Reality (XR) devices, wireless terminals in industrial control, wireless terminals in self-driving, wireless terminals in remote medical surgery, wireless terminals in smart grid, wireless terminals in transportation safety, wireless terminals in smart city, wireless terminals in smart home, etc.

A network device refers to a device that connects a terminal device to a wireless network. A network device may be a radio access network (RAN) node (or device) and/or a core network device, etc. In some embodiments, a network device may also be referred to as a base station. Currently, examples of some RAN nodes include: continued evolved Node B (gNB), Transmission Reception Point (TRP), Evolved Node B (eNB), Radio Network Controller (RNC), Node B (NB), Base Station Controller (BSC), Base Transceiver Station (BTS), home base station (e.g., Home Evolved NodeB, or Home Node B, HNB), Base Band Unit (BBU), or Wireless Fidelity (WiFi) Access Point (AP), etc. In addition, in a network structure, a network device may include a centralized unit (CU) node, a distributed unit (DU) node, or an RAN device including the CU node and the DU node. It should be noted that centralized unit nodes and distributed unit nodes may be designated by other terminologies, as the present application does not limit their specific nomenclature.

A satellite, referring to an artificial satellite, is an apparatus that orbits the Earth or other planets like a natural satellite. Satellites have a wide range of uses and may be categorized by purpose into: communication satellites, meteorological satellites, reconnaissance satellites, navigation satellites, positioning satellites, etc. The satellites involved in the embodiments of the present application are communication satellites, which may be categorized by a running orbit into: Low Earth Orbit (LEO) satellites, Very Low Earth Orbit (VLEO) satellites, Geostationary Earth Orbit (GEO) satellites, etc. Low Earth Orbit refers to an orbit about 600 to 1,200 kilometers above the Earth's surface, Very Low Earth Orbit refers to an orbit about 350 kilometers above the Earth's surface, and Geostationary Earth Orbit refers to an orbit about 35,786 kilometers above the Earth's surface. Communication based on Very Low Earth Orbit satellites has the characteristics of low transmission delay, low propagation loss, high regional capacity, and low cost, etc.

Any two terminal devices within the satellite's coverage area can communicate with each other, unaffected by geological disasters. The satellite may communicate with a network device, enabling the integration of non-terrestrial communication and terrestrial communication.

In the architecture shown in FIG. 1, the satellite and the network device are deployed separately by way of example. In some possible embodiments, the network device may be deployed on the satellite.

It is understandable that the communication system described in the embodiments of the present application is to illustrate the technical solutions of the embodiments of the present application more clearly and does not constitute a limitation on the technical solutions provided by the embodiments of the present application. Those skilled in the art will know that as the system architecture evolves and new service scenarios emerge, the technical solutions provided by the embodiments of the present application are equally applicable to similar technical problems.

Secondly, related concepts involved in embodiments of the present application are illustrated.

### 1. Beam and Beam Position

In the embodiments of the present application, a beam refers to a satellite beam, which is the shape formed on the Earth's surface by electromagnetic waves transmitted by a satellite antenna. A satellite may transmit at least one beam, e. g., reference may be made to the schematic diagram of the satellite transmitting two beams shown in FIG. 2.

For a satellite, its coverage area may be divided into a plurality of beam positions. For example, reference may be made to 37 beam positions shown in FIG. 2, that is, the satellite coverage area is divided into 37 beam positions. It should be noted that the beam positions in FIG. 2 are represented as circular areas or elliptical areas for illustrative purposes only. Beam positions may also be represented as rectangular areas, square areas or irregularly shaped areas. Here, the coverage area of the satellite may also be described as coverage range, coverage geographical area, or scanning area, etc. of the satellite.

A beam position may be associated with geographical location information. For example, a beam position may be associated with longitude and latitude information. In other words, a beam position may be represented by geographical location information. A beam position being associated with geographical location information may be interpreted as the beam position being associated with a geographical area. For example, Beam Position 0 in FIG. 2 represents a circular geographical area, the longitude and latitude of a central point of the circular geographical area are 140 °E-40 °N, and the radius of the circular geographical area is 1 km. That is, the geographical location information corresponding to Beam Position 0 includes a circular geographical area centered at 140 °E-40 °N with a 1 km radius. As another example, Beam Position 0 may be represented as a rectangular geographical area, the longitude and latitude information of the rectangular geographical area includes longitude from 120 °E to 140 °E and latitude from 60 °N to 80 °N.

A beam may be associated with a beam position. A scanning area of a beam is a beam position. A beam position being scanned by a beam may be referred to as the beam position being illuminated by a beam, or the beam position being illuminated, etc. For example, in FIG. 2, Beam Position 2 is illuminated, and terminal devices within Beam Position 2 can communicate. Beam Position 7 is illuminated, and terminal devices within Beam Position 7 can communicate. In contrast, a beam position not being scanned by a beam may be referred to as the beam position not being illuminated by a beam, or the beam position not being illuminated, etc. For exmaple, in FIG. 2, Beam Position 6 is not illuminated, and terminal devices within Beam Position 6 are temporarily unable to communicate.

Currently, each beam position within the satellite's coverage area is scanned by a beam in an equalized manner. That is, the dwell time for service of the beam at each beam position is the same or similar. A network device or a satellite may indicate a mode of equalized scanning via a broadcast message, and a terminal device may learn the dwell time for service of a beam at each beam position based on information predefinedin protocols. In other words, the protocol may predefine the dwell time for service of a each beam at each beam position. However, within the satellite's coverage area, service load of geographical areas corresponding to respective beam positions is typically uneven. For example, service load of the geographical area corresponding to Beam Position 0 may be greater than service load of the geographical area corresponding to Beam Position 6.If a beam keeps scanning each beam position in an equalized manner, the beam resources for the geographical area corresponding to Beam Position 0 may be insufficient, which could, to some extent, affect the communication quality of terminal devices in that geographical area. Meanwhile, the utilization of beam resources in the geographical area corresponding to Beam Position 6 is relatively low, resulting in waste of resources to some extent.

In view of this, embodiments of the present application provide a method for information transmission and a communication apparatus, which contributes to enhancing communication quality and resource utilization.

Next, the method for information tranmission provided by the embodiments of the present application is illustrated in detail.

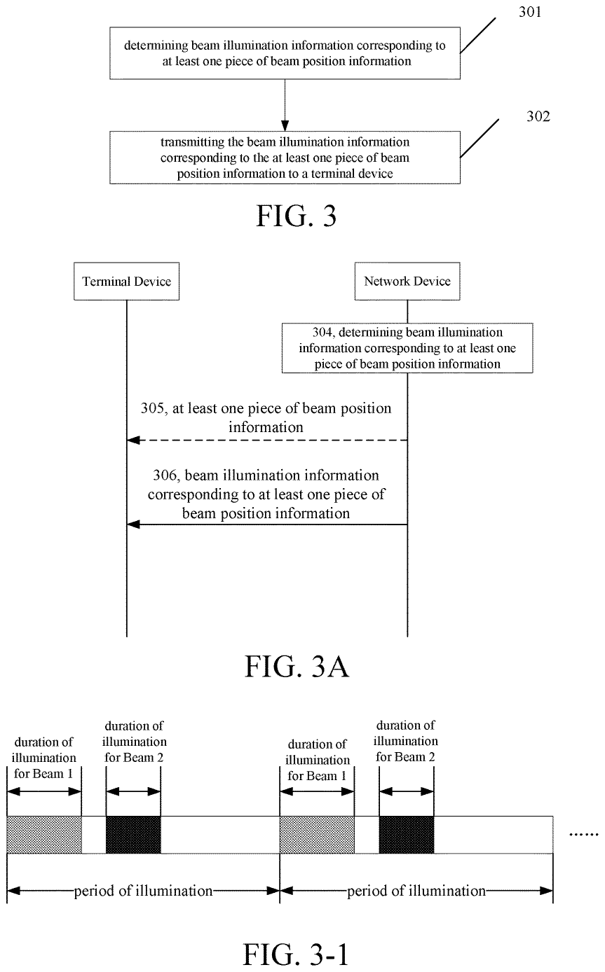

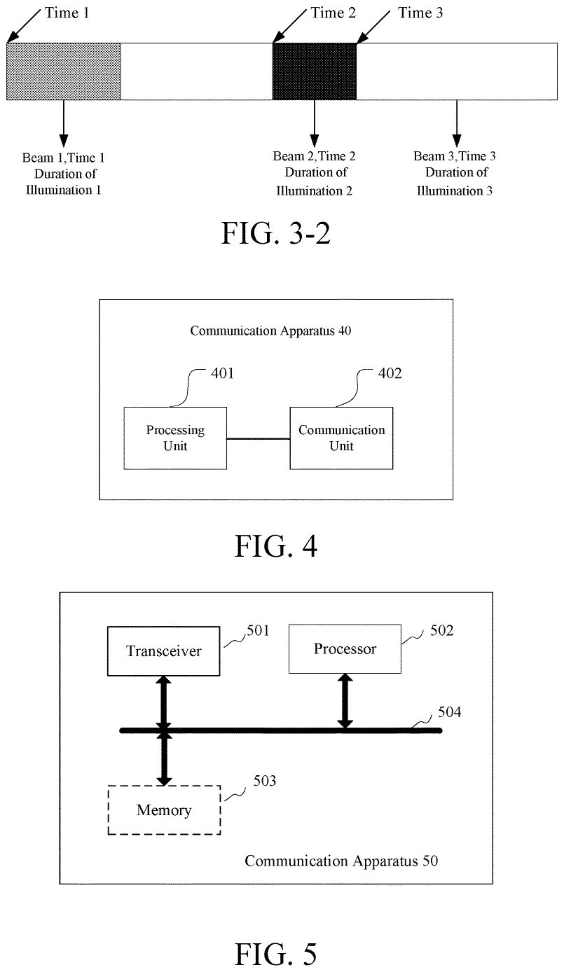

For example, referring to FIG. 3, which is a schematic flowchart of a method for information transmission provided by an embodiment of the present application. The flow may include but is not limited to the following steps: 301, determining beam illumination information corresponding to at least one piece of beam position information.

Here, beam position information is used to describe geographical location information corresponding to a beam position. That is, the beam position information is used to describe the geographical area corresponding to a beam position. The at least one piece of beam position information includes geographical location information corresponding to each beam position of at least one beam position, for example, the longitude and latitude information corresponding to each beam position. That is, a piece of beam position information includes the geographical location information corresponding to a beam position. Different beam positions correspond to different geographical location information, and different beam positions have different beam position information.

Alternatively, the number of the at least one piece of beam position information may be equal to the number of beam positions within the satellite's coverage area. For example, the number of the beam positions within the satellite's coverage area is 60, and the number of the at least one piece of beam position information may also be 60.Alternatively, the number of the at least one piece of beam position information may be less than the number of beam positions within the satellite's coverage area. For example, the number of the beam positions within the satellite's coverage area is 60, and the number of the at least one piece of beam position information may be 40.

In an implementation, a network device may acquire beam position information within the coverage area of a satellite from the satellite, thereby enabling the network device to transmit the at least one piece of beam position information to a terminal device.

The network device may transmit the at least one piece of beam position information to the terminal device via broadcast information. That is, the at least one piece of beam position information is carried in the broadcast information. Transmitting the at least one piece of beam position information via broadcast information may allow all terminal devices within a coverage range of the network device to receive the at least one piece of beam position information. Here, the broadcast information may be, for example, system broadcast information.

The network device may transmit the at least one piece of beam position information to the terminal device via dedicated signaling. That is, the at least one piece of beam position information is carried in the dedicated signaling. The dedicated signaling may be, for example, DCI, RRC signaling, or MAC-CE signaling, etc. Transmitting the at least one piece of beam position information via dedicated signaling may make the at least one piece of beam position information target-specific.

Alternatively, the at least one piece of beam position information may have a multiple-to-one correspondence to the beamillumination information, that is, a plurality of pieces of beam position information correspond to a piece of beam illumination information. In such a case, the number of the pieces of beam illumination information corresponding to the at least one piece of beam position information is less than the number of the at least one piece of beam position information, and the number of the pieces of beam illumination information corresponding to the at least one piece of beam position information may be one or more, depending on the configuration of the network device.

Alternatively, the at least one piece of beam position information may have a one-to-one correspondence to the beam illumination information, that is, a piece of beam position information corresponds to a piece of beam illumination information. In such a case, the number of the pieces of beam illumination information corresponding to the at least one piece of beam position information is the same as the number of the at least one piece of beam position information. Alternatively, different beam position information correspond to different beam illumination information.

In an example where a piece of beam position information corresponds to a piece of beam illumination information, a piece of beam illumination information may comprise an index of illuminating beam and time information of illuminating beam. The index of illuminating beam is associated with the time information of illuminating beam. In other words, a piece of beam illumination information may comprise an index of illuminating beam and time information of illuminating beam corresponding to the index of illuminating beam. The index of illuminating beam is used to indicate the beam(s) that can illuminate within the geographical area corresponding to the beam position information. For example, the index of illuminating beam corresponding to Beam Position 2 is used to indicate the beam(s) that can illuminate within the geographical area corresponding to Beam Position 2. The time information of illuminating beam corresponding to the index of illuminating beam is used to indicate the timing of illumination of the beam(s) that can illuminate within the geographical area corresponding to the beam position information. For example, the time information of illuminating beam corresponding to the index of illuminating beam which corresponds to Beam Position 2 is used to indicate the timing of illumination of the beam(s) that can illuminate within the geographical area corresponding to Beam Position 2.The terminal device can communicate during the time from the time information of illuminating beam corresponding to the index of illuminating beam, thereby enhancing communication quality and resource utilization.

The timing of illumination can be periodic or aperiodic.

In case of periodic illumination, the time information of illuminating beam may include a period of illumination and a duration of illumination within the period of illumination, where the duration of illumination may be understood as the time length of the illumination. For example, the period of illumination is 1 s and the duration of illumination is 10 ms, the beam(s) that can illumincate would illuminate for 10 ms every 1 s. As an example, reference may be made to the schematic diagram of beams illuminating in a periodic manner shown in FIG. 3-1, where the grey blocks indicate the duration of illumination for Beam 1 and the black blocks indicate the duration of illumination for Beam 2.

In case of aperiodic illumination, the time information of illuminating beam may include a start time of illumination and a duration of illumination, or it may include a start time of illumination and an end time of illumination. Alternatively, for aperiodic illumination, the beam illumination information corresponding to the at least one piece of beam position information may indicate the index of illuminating beam and the time information of illuminating beamvia a pattern. For example, a pattern may indicate the beam(s) that illuminate in respective time segments within a period of time as well as a start time of each time segment, where the duration of each time segment is the duration of illumination. As an example, reference may be made to the schematic diagram of beams illuminating in an aperiodic manner shown in FIG. 3-2, where the first grey block indicates the start time of illumination and the duration of illumination for Beam 1, the first black block indicates the start time of illumination and the duration of illumination for Beam 2, and the second white block indicates the start time of illumination and the duration of illumination for Beam 3.

In an implementation, the network device determines the beam illumination information corresponding to the at least one piece of beam position information based on current service load of the beam position(s) corresponding to the at least one piece of beam position information and/or historical service load of the beam position(s) corresponding to the at least one piece of beam position information. As can be seen, the network device can determine the beam illumination information based on current service load and/or historical service load of the beam position(s) corresponding to the beam position information, so that each beam position within the satellite's coverage area can be scanned based on service load, thereby contributing to the enhancement of communication quality and resource utilization. Alternatively, the network device determines the beam illumination information corresponding to the at least one piece of beam position information based on current service load of the beam position corresponding to each piece of beam position information of the at least one piece of beam position information, allowing the network device to adjust the beam illumination information corresponding to the at least one piece of beam position information in real time. Alternatively, the network device determines the beam illumination information corresponding to the at least one piece of beam position information based on historical service load of the beam position corresponding to each piece of beam position information of the at least one piece of beam position information. Alternatively, the network device determines the beam illumination information corresponding to the at least one piece of beam position information based on current service load and historical service load of the beam position corresponding to each piece of beam position information of the at least one piece of beam position information.

In another implementation, the network device determines the beam illumination information corresponding to the at least one piece of beam position information based on current amount of terminals of the beam position(s) corresponding to the at least one piece of beam position information and/or historical amount of terminals of the beam position(s) corresponding to the at least one piece of beam position information. The amount of terminals refers to the amount of terminal device(s) served.

The above two ways of determining the beam illumination information corresponding to the at least one piece of beam position information are provided for illustrative purposes only and shall not be construed as limiting the embodiments of the present application. For example, the beam illumination information corresponding to the at least one piece of beam position information may be determined according to service load in connection with amount of terminals.
302, transmitting the beam illumination information corresponding to the at least one piece of beam position information to a terminal device.

The network device may transmit the beam illumination information corresponding to the at least one piece of beam position information to the terminal device via broadcast information. That is, the beam illumination information corresponding to the at least one piece of beam position information is carried in the broadcast information. Transmitting the beam illumination information corresponding to the at least one piece of beam position information via broadcast information may allow all terminal devices within a coverage range of the network device to receive the beam illumination information corresponding to the at least one piece of beam position information. Alternatively, the at least one piece of beam position information and the beam illumination information corresponding to the at least one piece of beam position information may be carried in the same broadcast information or in different broadcast information.

The network device may transmit the beam illumination information corresponding to the at least one piece of beam position information to the terminal device via dedicated signaling. That is, the beam illumination information corresponding to the at least one piece of beam position information is carried in the dedicated signaling. The dedicated signaling may be, for example, DCI, RRC signaling, or MAC-CE signaling, etc. Transmitting the beam illumination information corresponding to the at least one piece of beam position information via dedicated signaling may make the beam illumination information corresponding to the at least one piece of beam position information target-specific. Alternatively, the at least one piece of beam position information and the beam illumination information corresponding to the at least one piece of beam position information may be carried in the same dedicated signaling or in different dedicated signaling.

Alternatively, the at least one piece of beam position information is carried in broadcast information, and the beam illumination information corresponding to the at least one piece of beam position information is carried in dedicated signaling. Or, the at least one piece of beam position information is carried in dedicated signaling, and the beam illumination information corresponding to the at least one piece of beam position information is carried in broadcast information.

In embodiments of the present application, the information carrying the beam illumination information corresponding to the at least one piece of beam position information is referred to as first information, and the first information may be broadcast information or dedicated signaling.

In the embodiment shown in FIG. 3, the network device determines and distributes to the terminal device the beam illumination information corresponding to the at least one piece of beam position information, so that each beam position within the satellite's coverage area is scanned based on for example service load rather than in an equalized manner, which contributes to enhancing communication quality and resource utilization. For example, referring to FIG. 3A, which is a schematic flowchart of another method for information transmission provided by an embodiment of the present application. The flow may include but is not limited to the following steps:
304, determining, by a network device, beam illumination information corresponding to at least one piece of beam position information.
306, transmiting, by the network device, the beam illumination information corresponding to the at least one piece of beam position information to a terminal device. Accordingly, the terminal device receives the beam illumination information corresponding to the at least one piece of beam position information from the network device.

Steps 304 and 306 may be implemented with reference to the detailed descriptions of steps 301 and 302 in the embodiment shown in FIG. 3, which are not repeated here for brevity.

Alternatively, before receiving the beam illumination information corresponding to the at least one piece of beam position information from the network device, the terminal device may further receive the at least one piece of beam position information. In an implementation, the terminal device may receive the at least one piece of beam position information from the network device. That is, in the embodiment shown in FIG. 3A, prior to Step 306, the method may further include transmitting, by the network device, the at least one piece of beam position information to the terminal device. The order of Step 305 and Step 304 is not specified. In another implementation, the terminal device may receive the at least one piece of beam position information from a satellite.

Alternatively, the beam position information of each satellite may be configured in the terminal device.

Alternatively, a terminal device in an idle state is not required to acquire beam illumination information from the network device in real time to maintain the latest beam illumination information. The terminal device is instead required to acquire the latest beam illumination information from the network device before initiating random access.

In an implementation, in case of receiving the beam illumination information corresponding to the at least one piece of beam position information, the terminal device, in response to first beam position information which corresponds to current geographical location information, determines first beam illumination information corresponding to the first beam position information from the beam illumination information corresponding to the at least one piece of beam position information. Here, the first beam position information is determined based on geographical location information corresponding to each beam position and the current geographical location information. That is, the terminal device determines the first beam position information corresponding to the current geographical location information based on the geographical location information corresponding to each beam position, and further determines the first beam illumination information corresponding to the first beam position information. [symbol] , [symbol] [symbol] [symbol] [symbol] [symbol] [symbol] Here, the current geographical location information refers to the geographical location information of the terminal device at the time the terminal device receives the beam illumination information corresponding to the at least one piece of beam position information.

It can be understood that the terminal device may determine the beam illumination information corresponding to the current geographical location information based on the beam illumination information corresponding to the at least one piece of beam position information, and communicate based on the beam illumination information corresponding to the current geographical location information.

Alternatively, the network device may also transmit at least one piece of time validity information to the terminal device. Accordingly, the terminal device also receives the at least one piece of time validity information from the network device. A piece of time validity information is used to indicate information on valid time for the beam illumination information corresponding to that piece of time validity information. That is, a piece of beam illumination information has time validity information, which may indicate information on valid time for that piece of beam illumination information. For example, the time validity information may include one or more of the following information: a start time of validity, a duration of validity, an end time of validity, etc. It can be understood that the network device sets validity in terms of time for the illumination duration informationfor flexibility.

Alternatively, the at least one piece of time validity information and the beam illumination information corresponding to the at least one piece of beam position information may be carried in the same broadcast information or in different broadcast information. Alternatively, the at least one piece of time validity information and the beam illumination information corresponding to the at least one piece of beam position information may be carried in the same dedicated signaling or in different dedicated signaling. Alternatively, the at least one piece of time validity information is carried in broadcast information, and the beam illumination information corresponding to the at least one piece of beam position information may be carried in dedicated signaling. Or, the at least one piece of time validity information is carried in dedicated signaling, and the beam illumination information corresponding to the at least one piece of beam position information may be carried in broadcast information.

Alternatively, the at least one piece of beam position information, the beam illumination information corresponding to the at least one piece of beam position information, and the at least one piece of time validity information may be carried in the same broadcast information or in different broadcast information. Alternatively, the at least one piece of beam position information, the beam illumination information corresponding to the at least one piece of beam position information, and the at least one piece of time validity information may be carried in the same dedicated signaling or in different dedicated signaling.

In the embodiment shown in FIG. 3A, the network device distributes the beam illumination information corresponding to the at least one piece of beam position information to the terminal device, so that each beam position within the satellite's coverage area is scanned based on for example service load rather than in an equalized manner, which contributes to enhancing communication quality and resource utilization.

As an alternative embodiment, a terminal device in a connected state may report its beam position information to the network device to acquire updated beam illumination information.

In an implementation, the terminal device transmits first beam position information to the network device. Accordingly, the network device receives the first beam position information from the terminal device. Here, the first beam position information is the beam position information corresponding to current geographical location information. The terminal device may determine the first beam position information corresponding to the current geographical location information according to the current geographical location information and the at least one piece of beam position information. Upon receiving the first beam position information, the network device detects whether the beam illumination information corresponding to the first beam position information can be updated, and if so, the network device returns the updated beam illumination information corresponding to the first beam position information to the terminal device. Here, the updated beam illumination information corresponding to the first beam position information is different from the beam illumination information corresponding to the first beam position information from the beam illumination information corresponding to the at least one piece of beam position information in Step 302.

Here, the updated beam illumination information corresponding to the first beam position information is carried in second information, and the second information is broadcast information, DCI, RRC signaling, or MAC-CE signaling.

In another implementation, the terminal device transmits a first request message to the network device. Accordingly, the network device receives the first request message from the terminal device. Here, the first request message includes first beam position information, and the first request message is used to request updated beam illumination information corresponding to the first beam position information. Upon receiving the first request message and in response to the fact that the beam illumination information corresponding to the first beam position information can be updated, the network device returns the updated beam illumination information corresponding to the first beam position information to the terminal device.

It can be seen that the terminal device acquires a piece of valid and updated beam illumination information to ensure data transmission, that is, the terminal device remains accessible during data transmission.

As an alternative embodiment, the terminal device may be in motion, and its geographical location information may change. A change in the geographical location information may lead to a change in beam position information. In the embodiments of the present application, the beam position information corresponding to the geographical location information of the terminal device after the movement of the terminal device is referred to as second beam position information, where the second beam position information is different from the first beam position information.

The terminal device transmits the second beam position information to the network device. Accordingly, the network device receives the second beam position information from the terminal device.

Alternatively, in case that the beam illumination information corresponding to the at least one piece of beam position information in Step 302 does not include the beam illumination information corresponding to the second beam position information, the terminal device transmits the second beam position information to the network device, and the second beam position information is used to request the beam illumination information corresponding to the second beam position information. The second beam position information may be carried in a second request message, and the second request message is used to request the beam illumination information corresponding to the second beam position information.

Alternatively, in case that the beam illumination information corresponding to the at least one piece of beam position information in Step 302 includes the beam illumination information corresponding to the second beam position information and the beam illumination information corresponding to the second beam position information is not invalid, the terminal device transmits the second beam position information to the network device to notify the network device that the beam position information corresponding to the geographical location information of the terminal device has changed to the second beam position information. The terminal device is not required to request the beam illumination information corresponding to the second beam position information. Here, the beam illumination information corresponding to the second beam position information being not invalid may be understood as the current time instance not beyond the time range from the time validity information corresponding to the beam illumination information. That is, the current time instance intersects with the time range from the time validity information corresponding to the beam illumination information. The current time instance refers to the time instance after the geographical location information has changed.

Alternatively, in case that the beam illumination information corresponding to the at least one piece of beam position information in Step 302 includes the beam illumination information corresponding to the second beam position information and that the beam illumination information corresponding to the second beam position information is invalid, the terminal device transmits the second beam position information to the network device, where the second beam position information is used to request the beam illumination information corresponding to the second beam position information. The second beam position information may be carried in a second request message, and the second request message is used to request the beam illumination information corresponding to the second beam position information.

That is, in case where a change in the geographical location information of the terminal device leads to a change in the beam position information, one or more of the following may be performed: transmitting the second beam position information to the network device;

transmitting a second request message to the network device, where the second request message includes the second beam position information, and the second request message is used to request the beam illumination information corresponding to the second beam position information.

Regarding the terminal device requesting the beam illumination information corresponding to the second beam position information, the network device may return the beam illumination information corresponding to the second beam position information to the terminal device. Alternatively, the beam illumination information corresponding to the second beam position information is not included in the beam illumination information corresponding to the at least one piece of beam position information in Step 302.Alternatively, the beam illumination information corresponding to the second beam position information is the updated beam illumination information.

It can be seen that in case where a change in the geographical location information of the terminal device leads to a change in the beam position information, the terminal device may request to acquire the beam illumination information corresponding to the changed beam position information, thereby ensuring data transmission.

Referring to FIG. 4, FIG. 4 is a schematic structural diagram of a communication apparatus provided by an embodiment of the present application. The communication apparatus 40 may be a terminal device or an apparatus configured for use with a terminal device. As shown in FIG. 4, the communication apparatus 40 includes a communication unit 402 and a processing unit 401.

In an implementation, the communication unit 402 is configured to receive beam illumination information corresponding to at least one piece of beam position information from a network device, where the beam illumination information corresponding to the at least one piece of beam position information includes an index of illuminating beam and time information of illuminating beam.

Alternatively, the time information of illuminating beam includes a period of illumination and a duration of illumination within the period of illumination, or the time information of illuminating beam includes a start time of illumination and a duration of illumination.

Alternatively, the communication unit 402 is further configured to receive the at least one piece of beam position information, where the at least one piece of beam position information includes geographical location information corresponding to each beam position of at least one beam position.

Alternatively, the processing unit 401 is configured to, in response to first beam position information corresponding to current geographical location information, determine first beam illumination information corresponding to the first beam position information from the beam illumination information corresponding to the at least one piece of beam position information, where the first beam position information is determined based on the geographical location information corresponding to each beam position and the current geographical location information.

Alternatively, the communication unit 402 is further configured to receive at least one piece of time validity information from the network device, where a piece of time validity information is used to indicate information on valid time for the beam illumination information corresponding to that piece of time validity information.

Alternatively, the beam illumination information corresponding to the at least one piece of beam position information is carried in first information, where the first information is broadcast information, DCI, RRC signaling, or MAC-CE signaling.

Alternatively, the communication unit 402 is further configured to: transmit first beam position information to the network device, where the first beam position information is the beam position information corresponding to current geographical location information; and receive updated beam illumination information corresponding to the first beam position information from the network device.

Alternatively, the updated beam illumination information corresponding to the first beam position information is carried in second information, where the second information is broadcast information, DCI, RRC signaling, or MAC-CE signaling.

Alternatively, the communication unit 402 is further configured to: transmit a first request message to the network device, where the first request message includes the first beam position information, and the first request message is used to request the updated beam illumination information corresponding to the first beam position information, where the first beam position information is the beam position information corresponding to the current geographical location information; and receive a first response message from the network device, where the first response message includes the updated beam illumination information corresponding to the first beam position information.

Alternatively, the communication unit 402 is further configured to perform at least one of the following:
transmitting second beam position information to the network device;
transmitting a second request message to the network device, where the second request message includes the second beam position information, and the second request message is used to request the beam illumination information corresponding to the second beam position information;
where, the second beam position information is the beam position information corresponding to the geographical location information of the terminal device after the movement of the terminal device.

Alternatively, the communication unit 402 is further configured to receive the beam illumination information corresponding to the second beam position information from the network device.

The communication apparatus 40 may be a network device or an apparatus configured for use with a network device. As shown in FIG. 4, the communication apparatus 40 includes a processing unit 401 and a communication unit 402.

In an implementation, the processing unit 401 is configured to determine beam illumination information corresponding to at least one piece of beam position information; and the communication unit 402 is configured to transmit the beam illumination information corresponding to the at least one piece of beam position information to a terminal device; where the beam illumination information corresponding to the at least one piece of beam position information includes an index of illuminating beam index and time information of illuminating beam.

Alternatively, the time information of illuminating beam includes a period of illumination and a duration of illumination within the period of illumination, or the time information of illuminating beam includes a start time of illumination and a duration of illumination.

Alternatively, the communication unit 402 is further configured to transmit the at least one piece of beam position information to the terminal device, where the at least one piece of beam position information includes geographical location information corresponding to each beam position of at least one beam position.

Alternatively, the communication unit 402 is further configured to transmit at least one piece of time validity information to the terminal device, where a piece of time validity information is used to indicate information on valid time for the beam illumination information corresponding to that piece of time validity information.

Alternatively, the beam illumination information corresponding to the at least one piece of beam position information is carried in first information, where the first information is broadcast information, DCI, RRC signaling, or MAC-CE signaling.

Alternatively, the communication unit 402 is further configured to: receive first beam position information from the terminal device, where the first beam position information is the beam position information corresponding to current geographical location information; and transmit updated beam illumination information corresponding to the first beam position information to the terminal device.

Alternatively, the updated beam illumination information corresponding to the first beam position information is carried in second information, where the second information is broadcast information, DCI, RRC signaling, or MAC-CE signaling.

Alternatively, the communication unit 402 is further configured to: receive a first request message from the terminal device, where the first request message includes the first beam position information, and the first request message is used to request the updated beam illumination information corresponding to the first beam position information, where the first beam position information is the beam position information corresponding to the current geographical location information; and transmit a first response message to the terminal device, where the first response message includes the updated beam illumination information corresponding to the first beam position information.

Alternatively, the communication unit 402 is further configured to perform at least one of the following:
receiving second beam position information from the terminal device;
receiving a second request message from the terminal device, where the second request message includes the second beam position information, and the second request message is used to request the beam illumination information corresponding to the second beam position information;
where, the second beam position information is the beam position information corresponding to the geographical location information of the terminal device after the movement of the terminal device.

Alternatively, the communication unit 402 is further configured to transmit the beam illumination information corresponding to the second beam position information to the terminal device.

Referring to FIG. 5, FIG. 5 is a schematic structural diagram of another communication apparatus provided by an embodiment of the present application. The communication apparatus 50 may be a terminal device or an apparatus configured for use with a terminal device. Alternatively, the communication apparatus may further include a memory 503. Here, the transceiver 501, the processor 502, and the memory 503 may be connected via a bus 504 or connected in other forms. The bus is represented in a bold line in FIG. 5. The forms of connection between other components are only for schematic illustration and are not for limitation. The bus may be classified as an address bus, a data bus, a control bus, etc. For ease of illustration, only one bold line is shown in FIG. 5, but it does not mean that there is only one bus or one type of bus.

“Coupling” in the embodiments of the present application is indirect coupling or communication connection between devices, units, or modules, which may be electrical, mechanical, or other forms, and are used for information interaction between devices, units, or modules. In the embodiments of the present application, the medium for connection between the transceiver 501, the processor 502, and the memory 503 is not specifically limited herein.

The memory 503 may include read-only memory and random access memory, and provides instructions and data to the processor 502.A part of the memory 503 may also include non-volatile random access memory.

The processor 502 may be a Central Processing Unit (CPU), or the processor 502 may also be another general-purpose processor, a Digital Signal Processor (DSP), an Application Specific Integrated Circuit (ASIC), a Field-Programmable Gate Array (FPGA), or another programmable logic device, discrete gate or transistor logic device, discrete hardware component, etc. The general-purpose processor may be a microprocessor, or alternatively, the processor 502 may be any conventional processor, etc.

In an alternative embodiment, the memory 503 is configured to store program instructions; and the processor 502 is configured to invoke the program instructions stored in the memory 503 to perform the steps executed by the terminal device in the embodiments corresponding to FIG. 3 and FIG. 3A.

In an alternative embodiment, the memory 503 is configured to store program instructions; and the processor 502 is configured to invoke the program instructions stored in the memory 503 to perform the steps executed by the network device in the embodiments corresponding to FIG. 3 and FIG. 3A.

In the embodiments of the present application, the methods provided by the embodiments of the present application may be implemented by executing computer programs (including program codes) capable of performing the steps related to the above methods on a general purpose computing device such as a computer that includes processing elements and storage elements, such as a CPU, Random Access Memory (RAM), Read-Only Memory (ROM), etc. The computer programs may be recorded on, for example, a computer-readable recording medium, loaded into the above computing device through the computer-readable recording medium, and executed therein.

Based on the same inventive concept, the principle for solving problems and beneficial effects of the communication apparatus 50 provided in the embodiments of the present application are similar to those in the embodiments shown in FIG. 3 and FIG. 3A of the present application. Reference may be made to the principles and beneficial effects of the method implementations. For brevity, details are not repeated herein.

The above communication apparatus may be, for example, a chip or a chip module.

The embodiments of the present application also provide a chip, and the chip inludes a processor configured to perform the relevant steps of the terminal device in the method embodiments mentioned above.

In an implementation, the chip is configured to: receive beam illumination information corresponding to at least one piece of beam position information from a network device; where the beam illumination information corresponding to the at least one piece of beam position information includes an index of illuminating beam and time information of illuminating beam.

Alternatively, the time information of illuminating beam includes a period of illumination and a duration of illumination within the period of illumination, or the time information of illuminating beam includes a start time of illumination and a duration of illumination.

Alternatively, the chip is further configured to receive the at least one piece of beam position information, where the at least one piece of beam position information includes geographical location information corresponding to each beam position of at least one beam position.

Alternatively, the chip is further configured to, in response to first beam position information corresponding to current geographical location information, determine first beam illumination information corresponding to the first beam position information from the beam illumination information corresponding to the at least one piece of beam position information, where the first beam position information is determined based on the geographical location information corresponding to each beam position and the current geographical location information.

Alternatively, the chip is further configured to receive at least one piece of time validity information from the network device, where a piece of time validity information is used to indicate information on valid time for the beam illumination information corresponding to that piece of time validity information.

Alternatively, the beam illumination information corresponding to the at least one piece of beam position information is carried in first information, where the first information is broadcast information, DCI, RRC signaling, or MAC-CE signaling.

Alternatively, the chip is further configured to: transmit first beam position information to the network device, where the first beam position information is the beam position information corresponding to current geographical location information; and receive updated beam illumination information corresponding to the first beam position information from the network device.

Alternatively, the updated beam illumination information corresponding to the first beam position information is carried in second information, where the second information is broadcast information, DCI, RRC signaling, or MAC-CE signaling.

Alternatively, the chip is further configured to: transmit a first request message to the network device, where the first request message includes the first beam position information, and the first request message is used to request the updated beam illumination information corresponding to the first beam position information, where the first beam position information is the beam position information corresponding to the current geographical location information; and receive a first response message from the network device, where the first response message includes the updated beam illumination information corresponding to the first beam position information.

Alternatively, the chip is further configured to perform at least one of the following:
transmitting second beam position information to the network device;
transmitting a second request message to the network device, where the second request message includes the second beam position information, and the second request message is used to request the beam illumination information corresponding to the second beam position information;
where, the second beam position information is the beam position information corresponding to the geographical location information of the terminal device after the movement of the terminal device.

Alternatively, the chip is further configured to receive the beam illumination information corresponding to the second beam position information from the network device.

In another implementation, the chip is configured to: determine beam illumination information corresponding to at least one piece of beam position information; and transmit the beam illumination information corresponding to the at least one piece of beam position information to a terminal device;
where the beam illumination information corresponding to the at least one piece of beam position information includes an index of illuminating beam and time information of illuminating beam.

Alternatively, the time information of illuminating beam includes a period of illumination and a duration of illumination within the period of illumination, or the time information of illuminating beam includes a start time of illumination and a duration of illumination.

Alternatively, the chip is further configured to transmit the at least one piece of beam position information to the terminal device, where the at least one piece of beam position information includes geographical location information corresponding to each beam position of at least one beam position.

Alternatively, the chip is further configured to transmit at least one piece of time validity information to the terminal device, where a piece of time validity information is used to indicate information on valid time for the beam illumination information corresponding to that piece of time validity information.

Alternatively, the beam illumination information corresponding to the at least one piece of beam position information is carried in first information, where the first information is broadcast information, DCI, RRC signaling, or MAC-CE signaling.

Alternatively, the chip is further configured to: receive first beam position information from the terminal device, where the first beam position information is the beam position information corresponding to current geographical location information; and transmit updated beam illumination information corresponding to the first beam position information to the terminal device.

Alternatively, the updated beam illumination information corresponding to the first beam position information is carried in second information, where the second information is broadcast information, DCI, RRC signaling, or MAC-CE signaling.

Alternatively, the chip is further configured to: receive a first request message from the terminal device, where the first request message includes the first beam position information, and the first request message is used to request the updated beam illumination information corresponding to the first beam position information, where the first beam position information is the beam position information corresponding to the current geographical location information; and transmit a first response message to the terminal device, where the first response message includes the updated beam illumination information corresponding to the first beam position information.

Alternatively, the chip is further configured to perform at least one of the following:
receiving second beam position information from the terminal device;
receiving a second request message from the terminal device, where the second request message includes the second beam position information, and the second request message is used to request the beam illumination information corresponding to the second beam position information;
where, the second beam position information is the beam position information corresponding to the geographical location information of the terminal device after the movement of the terminal device.

Alternatively, the chip is further configured to transmit the beam illumination information corresponding to the second beam position information to the terminal device.

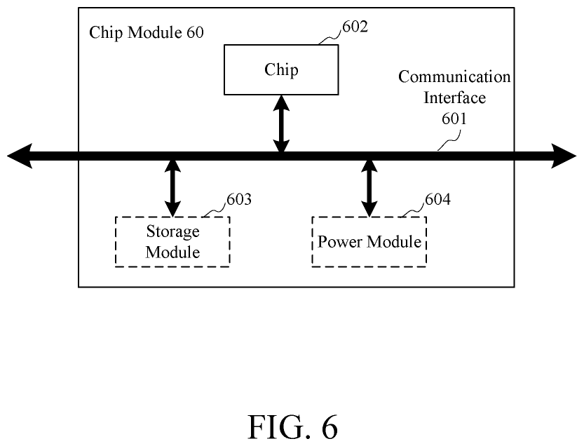

Referring to FIG. 6, FIG. 6 is a schematic structural diagram of a chip module provided by an embodiment of the present application. The chip module 60 may perform the related steps of the terminal device in the method embodiments mentioned above, and the chip module 60 includes: a communication interface 601 and a chip 602.

Here, the communication interface is configured for internal communication within the chip module, or for communication between the chip module and external devices. The communication interface may also be described as a communication module. The chip 602 is configured to implement the functions of the terminal device in the embodiments of the present application.

For example, the chip 602 is configured to receive beam illumination information corresponding to at least one piece of beam position information from a network device, where the beam illumination information corresponding to the at least one piece of beam position information includes an index of illuminating beam and time information of illuminating beam.

The chip 602 is configured to implement the functions of the network device in the embodiments of the present application.

For example, the chip 602 is configured to: determine beam illumination information corresponding to at least one piece of beam position information; and transmit the beam illumination information corresponding to the at least one piece of beam position information to the terminal device, where the beam illumination information corresponding to the at least one piece of beam position information includes an index of illuminating beam and time information of illuminating beam.

Alternatively, the chip module 60 may further include a storage module 603 and a power module 604. The storage module 603 is configured to store data and instructions. The power module 604 is configured to provide power for the chip module.

For apparatuses or products applied to or integrated into a chip module, each module included may be implemented in hardware such as circuits, and different modules may be located in the same component (e.g., chip, circuit module, etc.) or different components of the chip module, or at least some modules may be implemented by software programs executing on a processor integrated into the chip module, and the remaining (if any) modules may be implemented in hardware such as circuits.

An embodiment of the present application also provides a computer-readable storage medium having stored therein one or more instructions that are adapted to be loaded by a processor to implement the methods provided by the above method embodiments.

An embodiment of the present application also provides a computer program product including computer programs or instructions, the computer programs or instructions, when being executed on a computer, causing the computer to perform the methods provided by the above method embodiments.

It should be noted that the embodiments mentioned above are described as a combination of a series of actions for a brevity of description. Those skilled in the art should appreciate that the present application is not limited by the described sequence of actions, as some steps in the embodiments of the present application may be performed in other sequences or simultaneously. In addition, those skilled in the art should also appreciate that the embodiments described in the specification are all preferred embodiments, and not all the actions, steps, modules or units involved are required by the embodiments of the present application.

In the embodiments mentioned above, the descriptions of the various embodiments in the present application each emphasize different aspects. For portions not described in detail in a particular embodiment, reference may be made to the relevant descriptions in other embodiments.

The steps of methods or algorithms described in the embodiments of the present application may be implemented in hardware, or may be implemented by a processor executing software instructions. The software instructions may consist of corresponding software modules, which may be stored in a RAM, flash memory, ROM, erasable programmable ROM (EPROM), electrically erasable programmable ROM (EEPROM), register, hard disk, portable hard disk, CD-ROM, or any other form of storage medium known in the art. An exemplary storage medium is coupled to the processor, thereby enabling the processor to read information from the storage medium and write information to the storage medium. Certainly, the storage medium may also be an integral part of the processor. The processor and the storage medium may reside in an ASIC. Additionally, the ASIC may be located in a terminal device or a management device. Certainly, the processor and the storage medium may also exist as discrete components in a terminal device or a management device.

Those skilled in the art should appreciate that in one or more of the above examples, the functions described in the embodiments of the present application may be implemented entirely or partially through software, hardware, firmware, or any combination thereof. When implemented through software, these functions may be entirely or partially implemented in the form of a computer program product. The computer program product includes one or more computer instructions. When the computer program instructions are loaded and executed on a computer, the processes or functions described in the embodiments of the present application are entirely or partially generated. The computer may be a general-purpose computer, a special-purpose computer, a computer network, or other programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in wired manner (e.g., coaxial cable, optical fiber, digital subscriber line (DSL)) or in wireless manner (e.g., infrared, wireless, microwave, etc.). The computer-readable storage medium may be any available medium that can be accessed by a computer or a data storage device, such as a server or data center, integrating one or more available media. The available medium may be a magnetic medium (e.g., floppy disk, hard disk, magnetic tape), an optical medium (e.g., digital video disc (DVD)), or a semiconductor medium (e.g., solid state disk (SSD)), etc.

The various modules/units included in various apparatuses and products described in the above embodiments may be software modules/units, hardware modules/units, or partly software modules/units and partly hardware modules/units. For example, for apparatuses or products applied to or integrated into a chip, each module/unit included may be implemented in hardware such as circuits, or at least some modules/units may be implemented in software programs executing on a processor integrated into the chip, and the remaining (if any) modules/units may be implemented in hardware such as circuits; for apparatuses or products applied to or integrated into a chip module, each module/unit included may be implemented in hardware such as circuits, and different modules/units may be located in the same component (e.g., chip, circuit module, etc.) or different components of the chip module, or at least some modules/units may be implemented in software programs executing on a processor integrated into the chip module, and the remaining (if any) modules/units may be implemented in hardware such as circuits; for apparatuses or products applied to or integrated into a terminal, each module/unit included may be implemented in hardware such as circuits, different modules/units may be located in the same component (e.g., chip, circuit module, etc.) or different components of the terminal, or at least some modules/units may be implemented by software programs executing on a processor integrated into the terminal, and the remaining (if any) modules/units may be implemented in hardware such as circuits.

The specific implementations described above provide further detailed explanation regarding the objectives, technical solutions, and beneficial effects of the embodiments of the present application. It should be understood that these descriptions are merely illustrative of specific implementations of the embodiments of the present application and are not intended to limit the protection scope of the embodiments of the present application. Any modifications, equivalent replacements, or improvements made based on the technical solutions of the embodiments of the present application shall fall within the protection scope of the embodiments of the present application.

1. A method for information transmission, characterized in that comprising:
determining beam illumination information corresponding to at least one piece of beam position information;
transmitting the beam illumination information corresponding to the at least one piece of beam position information to a terminal device;
wherein the beam illumination information corresponding to the at least one piece of beam position information includes an index of illuminating beam and time information of illuminating beam.

2. The method according to claim 1, characterized in that said determining beam illumination information corresponding to at least one piece of beam position information comprising:
determining the beam illumination information corresponding to the at least one piece of beam position information based on current service load of a beam position corresponding to the at least one piece of beam position information and/or historical service load of a beam position corresponding to the at least one piece of beam position information.

3. The method according to claim 1, characterized in that the time information of illuminating beam includes a period of illumination and a duration of illumination within the period of illumination, or the time information of illuminating beam includes a start time of illumination and a duration of illumination.

4. The method according to claim 1, characterized in that the method further comprising:
transmitting the at least one piece of beam position information to the terminal device, wherein the at least one piece of beam position information includes geographical location information corresponding to each beam position of at least one beam position.

5. The method according to claim 1, characterized in that the method further comprising:
transmitting at least one piece of time validity information to the terminal device, a piece of time validity information indicating information on valid time for the beam illumination information corresponding to the piece of time validity information.

6. The method according to claim 1, characterized in that the beam illumination information corresponding to the at least one piece of beam position information is carried in first information, wherein the first information is broadcast information, downlink control information DCI, radio resource control RRC signaling, or media access control-control element MAC-CE signaling.

7. The method according to claim 1, characterized in that the method further comprising:
receiving first beam position information from the terminal device; and
transmitting updated beam illumination information corresponding to the first beam position information to the terminal device.

8. (canceled)

9. The method according to claim 1, characterized in that the method further comprising:
receiving a first request message from the terminal device, wherein the first request message includes first beam position information, and the first request message in request for the updated beam illumination information corresponding to the first beam position information; and
transmitting a first response message to the terminal device, wherein the first response message includes the updated beam illumination information corresponding to the first beam position information.

10. The method according to claim 1, characterized in that the method further comprising at least one of:
receiving second beam position information from the terminal device;
receiving a second request message from the terminal device, wherein the second request message includes second beam position information, and the second request message in request for beam illumination information corresponding to the second beam position information;
wherein the second beam position information is beam position information corresponding to geographical location information of the terminal device after movement.

11. (canceled)

12. A method for information transmission, characterized in comprising:
receiving beam illumination information corresponding to at least one piece of beam position information from a network device; wherein the beam illumination information corresponding to the at least one beam piece of position information includes an index of illuminating beam and time information of illuminating beam.

13. The method according to claim 12, characterized in that the time information of illuminating beam includes a period of illumination and a duration of illumination within the period of illumination, or the time information of illuminating beam includes a start time of illumination and a duration of illumination.

14. The method according to claim 12, characterized in that the method further comprising:
receiving the at least one piece of beam position information, wherein the at least one piece of beam position information includes geographical location information corresponding to each beam position of at least one beam position.

15. The method according to claim 14, characterized in that the method further comprising:
in response to first beam position information corresponding to current geographical location information, determining first beam illumination information corresponding to the first beam position information from the beam illumination information corresponding to the at least one piece of beam position information;
wherein the first beam position information is determined based on geographical location information corresponding to each beam position and the current geographical location information.

16. The method according to claim 12, characterized in that the method further comprising:
receiving at least one piece of time validity information from the network device, a piece of time validity information indicating information on valid time for the beam illumination information corresponding to the piece of time validity information.

17. The method according to claim 12, characterized in that the beam illumination information corresponding to the at least one piece of beam position information is carried in first information, wherein the first information is broadcast information, DCI, RRC signaling, or MAC-CE signaling.

18. The method according to claim 12, characterized in that the method further comprising:
transmitting first beam position information to the network device, wherein the first beam position information is beam position information corresponding to current geographical location information; and
receiving updated beam illumination information corresponding to the first beam position information from the network device.

19. (canceled)

20. The method according to claim 12, characterized in that the method further comprising:
transmitting a first request message to the network device, wherein the first request message includes first beam position information, and the first request message in request for the updated beam illumination information corresponding to the first beam position information, and wherein the first beam position information is beam position information corresponding to current geographical location information; and
receiving a first response message from the network device, wherein the first response message includes the updated beam illumination information corresponding to the first beam position information.

21. The method according to claim 12, characterized in that the method further comprising at least one of:
transmitting second beam position information to the network device;
transmitting a second request message to the network device, wherein the second request message includes second beam position information, and the second request message in request for the beam illumination information corresponding to the second beam position information;
wherein the second beam position information is beam position information corresponding to geographical location information of the terminal device after movement.

22. The method according to claim 21, characterized in that the method further comprising:
receiving the beam illumination information corresponding to the second beam position information from the network device.

23. A communication apparatus, characterized in that the communication apparatus comprising:
a processing unit configured to determine beam illumination information corresponding to at least one piece of beam position information; and
a communication unit configured to transmit the beam illumination information corresponding to the at least one piece of beam position information to a terminal device;
wherein the beam illumination information corresponding to the at least one piece of beam position information includes an index of illuminating beam and time information of illuminating beam.

24-29. (canceled)
